(19) United States
(12) Patent Application Publication
(10) Pub. No.: US 2010/0319165 A1
(43) Pub. Date: Dec. 23, 2010

(54) Cable Holder Arrangement

(76) Inventor: Harry Skarpil, Dortmund (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/528,331

(22) PCT Filed: Feb. 4, 2008
(86) PCT No.: PCT/EP2008/051345

§ 371 Date: Aug. 24, 2009

(30) Foreign Application Priority Data
Feb. 23, 2007 (DE) 10 2007 009 015.5

(51) Int. Cl. F16G 11/02; B23P 19/04; F16G 11/00

(52) U.S. Cl. 24/115 A; 29/428; 24/115 R

(57) ABSTRACT

A cable holder arrangement, including a protective tube, through which one or more cables are run with radial play, a cable retainer strap, arranged on a holder element at one end thereof and enclosing the protective tube and pulled with the free end region thereof through an opening on the holder element to make enclosing contact with the protective tube and prevented from making a movement in the direction of release of the enclosing contact by a blocking means. The cable is enclosed by a spacer in the region of the cable retainer strap the outer diameter of which approximately corresponds to the inner diameter of the protective tube.

### PRIORITY CLAIM

This is a U.S. national stage of application No. PCT/EP2008/051345, filed on 4 Feb. 2008, which claims Priority to the German Application No.: 10 2007 009 015.5, filed: 23 Feb. 2007 the contents of both being incorporated herein by reference.

### BACKGROUND OF THE INVENTION

1. Field of the Invention

The invention relates to a cable holder arrangement having a protective tube through which one or more cables are routed with radial play, the cable holder having a cable tie strip which, by way of one of its ends, is arranged on a holder element, surrounds the protective tube and, by way of its free end region, is pulled through a passage opening, which is arranged in the holder element, until it comes to bear against the protective tube so as to surround it, and is arrested against movement in the direction which releases the surrounding abutment by arresting means.

2. Prior Art

Cable holder arrangements of this type are intended both to fix the protective tube in a specific extension profile and to prevent relative displacement between the protective tube and the cable.

To this end, it is necessary for the cable tie strip to exert a high wrap-around force on the protective tube such that the protective tube wraps firmly around and holds the cable or cables.

In this case, there is a risk of the protective tube being constricted by the cable tie strip.

### SUMMARY OF THE INVENTION

An object of the invention is to provide a cable holder arrangement which prevents constriction of the protective tube by the cable tie strip.

According to one embodiment of the invention, this object is achieved in that the cable or cables is/are surrounded by a sleeve-like spacer in the region of the cable tie strip, the outside diameter of said sleeve-like spacer corresponding approximately to the inside diameter of the protective tube.

Since the protective tube is supported by its inner wall on the spacer of approximately the same diameter, constriction of the protective tube is prevented even in the event of very high wrap-around forces of the cable tie strip.

At the same time, the protective tube is held firmly on the spacer by the wrap-around forces and prevents relative displacement of the protective tube and spacer.

The protective tube is preferably a corrugated tube and an outside diameter of the spacer approximately corresponds to an inside diameter of the inner corrugations of the corrugated tube.

Constriction is prevented in this case by the radial webs of the corrugated tube being firmly supported on the spacer.

For the purposes of simple fitting, the spacer is arranged firmly on the cable or cables.

Spacers are arranged on the cable or cables, before insertion into the protective tube, at distances which correspond to the distances between the cable tie strips. The spacers are in the position of the cable tie strips after insertion of the cables.

The spacer which is firmly arranged on the cable or cables prevents relative movement between the protective tube and cables.

For simple mounting, the spacer can surround the cable or cables with radial prestress.

However, it is also possible for the spacers to be firmly arranged on the cables by adhesive bonding.

In order to enable the cables provided with the spacers to be easily inserted into the protective tube, the spacer is conically tapered in the direction of one or both of its axial ends.

The spacer can be fitted in a particularly simple manner by the spacer being composed of an elastically deformable material and having an axially continuous longitudinal slot.

The spacer does not have to be pushed over a large portion of the cable, but can be secured on the cable or cables directly at the intended location with elastic expansion.

In order to mount the cable holder arrangement in a stationary position, for example on a body part of a motor vehicle, the holder element may have a holder pin that extends radially in relation to the protective tube and can be inserted into a corresponding recess in the fixed component, such as the body part.

To mount the holder pin in the recess in the fixed component, the holder pin is preferably a threaded pin or a profiled pin.

To save on outlay on fitting, the cable tie strip and the holder element may be of integral design.

The cable tie strip and/or the holder element are/is preferably plastic.

### BRIEF DESCRIPTION OF THE DRAWINGS

In the Figures:

FIG. 1 is a perspective plan view of a cable holder arrangement;

FIG. 2 is a perspective view of the cable holder of FIG. 1 from below;

FIG. 3 is a cross section through the cable holder arrangement of FIG. 1; and

FIG. 4 is a perspective view of a spacer of the cable holder arrangement of FIG. 1.

### DETAILED DESCRIPTION OF THE DRAWINGS

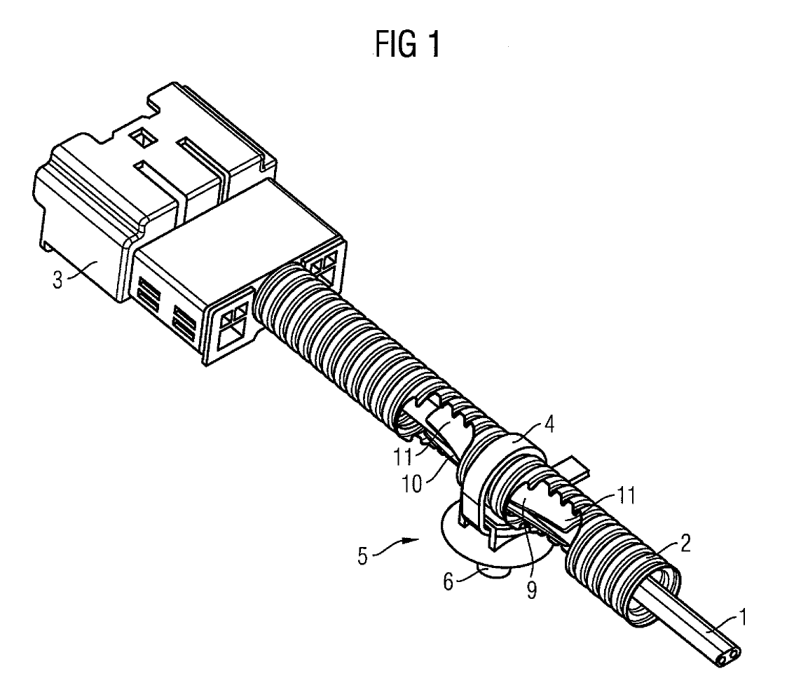

A cable 1, shown in FIG. 1, which has two cores to form a cable harness, is routed through a protective tube 2, which is in the form of a corrugated tube, to a connector 3 with radial play.

The protective tube 2 preferably extends as far as the connector 3.

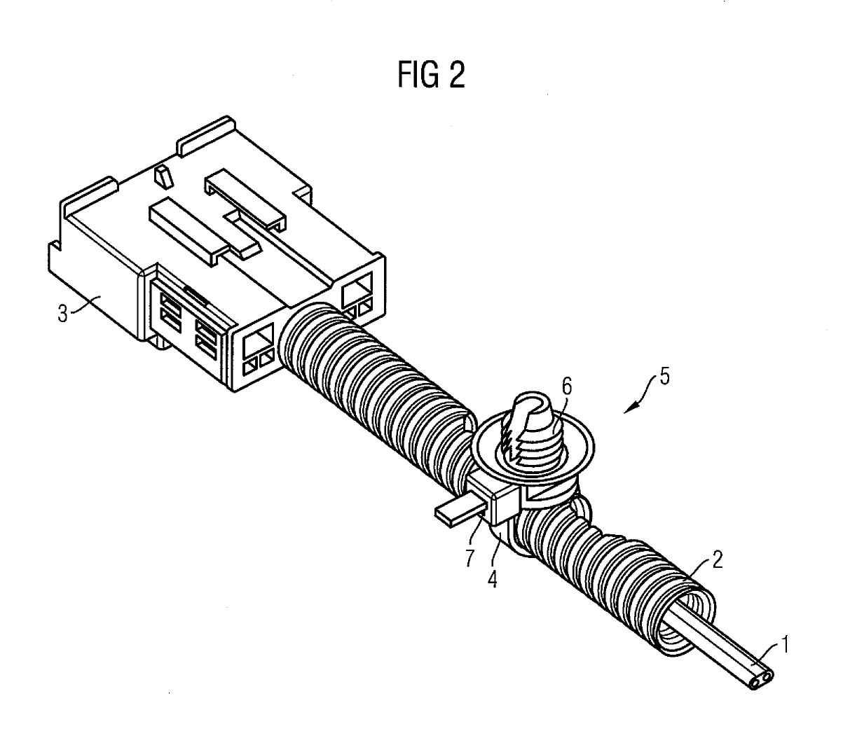

As shown in FIGS. 1 and 2, the protective tube 2 is firmly surrounded by a cable tie strip 4 of a cable holder element 5 at a distance from the connector 3.

A profiled pin 6 which can be inserted into a corresponding opening in a fixed component (not illustrated), for example a body part of a motor vehicle, is integrally formed with the cable holder element 5.

As can be seen in FIG. 2, one end of the cable tie strip 4 is firmly arranged on the cable holder element 5, whereas the free end region of the cable tie strip 4 is pulled through a passage opening 7 in the cable holder element 5 until the cable tie strip 4 surrounds the protective tube 2 with prestress.

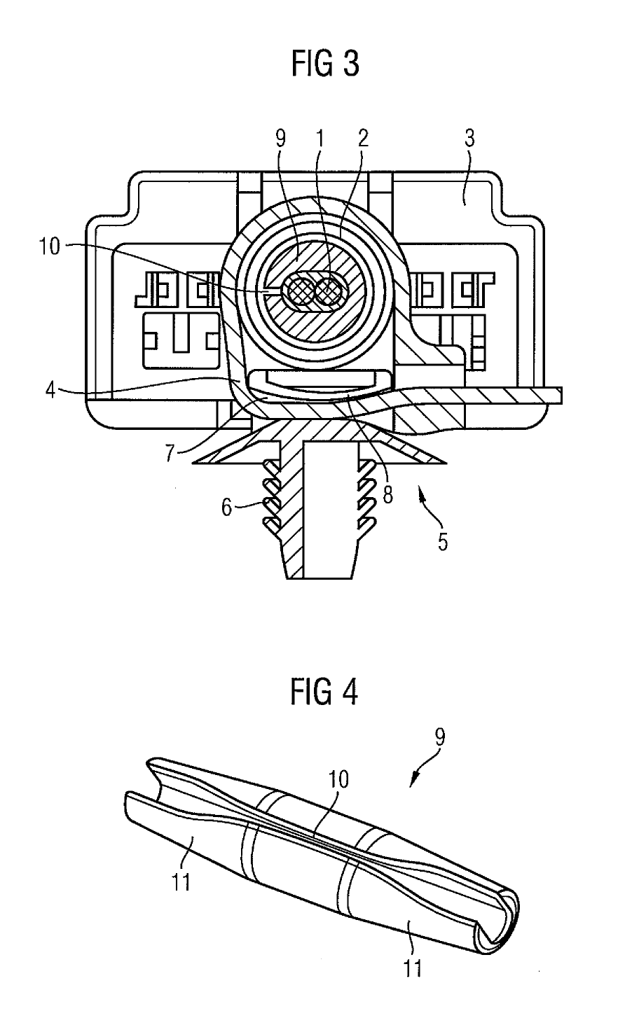

Arresting means, shown in FIG. 3, in the form of barbs 8 by means of which movement of the cable tie strip 4 in the direction which releases the surrounding abutment against the protective tube 2 is blocked, are arranged in the passage opening 7.

A sleeve-like spacer 9 shown in FIG. 4, is arranged on the cable 1 in the region of the cable holder element 5, said sleeve-like spacer surrounding the cable 1 with radial prestress and the outside diameter of said sleeve-like spacer corresponding to the inside diameter of the protective tube 2.

For the purpose of simple fitting, the spacer 9 which is composed of an elastically deformable plastic has an axially continuous longitudinal slot 10.

For the purpose of simple insertion of the cable 1, which is provided with the spacer 9, into the protective tube 2, the two axial ends 11 of the spacer 9 are conically tapered.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-10. (canceled)

11. A cable holder arrangement comprising:
a protective tube through which at least one cable is routed with radial play;
a holder element having a passage opening;
a cable tie strip having a first end arranged on the holder element and a free end adapted to be pulled through the passage opening, the cable tie strip configured to surround and bear against the protective tube arranged in the holder element, the cable tie strip being arrested against movement through the passage opening in a direction that releases the cable tie strip by arresting means; and
a sleeve-like spacer configured to surround the at least one cable in the region of the cable tie strip, an outside diameter of the sleeve-like spacer substantially corresponding to an inside diameter of the protective tube.

12. The cable holder arrangement of claim 11, wherein the protective tube is a corrugated tube and the outside diameter of the sleeve-like spacer substantially corresponds to the inside diameter of the inner corrugations of the corrugated tube.

13. The cable holder arrangement of claim 11, wherein the sleeve-like spacer is configured such that an inner diameter of the sleeve-like spacer substantially corresponds to the outer diameter of the at least one cable.

14. The cable holder arrangement of claim 13, wherein the sleeve-like spacer surrounds the at least one cable with radial prestress.

15. The cable holder arrangement of claim 11, wherein the sleeve-like spacer is conically tapered in the direction of at least one of its axial ends.

16. The cable holder arrangement of claim 11, wherein the sleeve-like spacer is elastically deformable material and the sleeve-like spacer further comprises has an axially continuous longitudinal slot.

17. The cable holder arrangement of claim 11, wherein the holder element further comprises a holder pin that extends radially from the holder element with respect to the protective tube.

18. The cable holder arrangement of claim 17, wherein the holder pin is at least one of a threaded pin and a profiled pin.

19. The cable holder arrangement of claim 11, wherein the cable tie strip and the holder element are of integral design.

20. The cable holder arrangement of claim 11, wherein at least one of the cable tie strip, the holder element, and the sleeve-like spacer are plastic.

21. The cable holder arrangement of claim 13, wherein the sleeve-like spacer is attached to the at least one cable with an adhesive.

22. The cable holder arrangement of claim 11, wherein the arresting means are configured as barbs.

23. A cable holder arrangement comprising:
a protective tube through which at least one cable is routed with radial play;
a holder element;
a cable retaining device coupled to the holder element and configured to surround and bear against the protective tube; and
a sleeve-like spacer configured to surround the at least one cable in the region of the cable retaining device, an outside diameter of the sleeve-like spacer substantially corresponding to an inside diameter of the protective tube.

23. A method of assembling a cable holder arrangement comprising:
arranging a spacer on at least one cable at a location corresponding to a holder element;
inserting the at least one cable in a protective tube; and
affixing the protective tube to the holder element.
